(19) United States
(12) Patent Application Publication
(10) Pub. No.: US 2022/0414151 A1
(43) Pub. Date: Dec. 29, 2022

(54) Method for Operating a Surroundings Sensing Device with Grid-Based Evaluation and with Fusion, and Surroundings Sensing Device

(71) Applicant: Bayerische Motoren Werke Aktiengesellschaft, Muenchen (DE)

(72) Inventors: Sascha STEYER, Muenchen (DE); Georg TANZMEISTER, Muenchen (DE)

(21) Appl. No.: 17/780,272

(22) PCT Filed: Nov. 3, 2020
(86) PCT No.: PCT/EP2020/080782

§ 371 Date: May 26, 2022

(30) Foreign Application Priority Data
Nov. 28, 2019 (DE) 10 2019 132 363.0

(51) Int. Cl. G06F 16/901

(52) U.S. Cl. CPC G06F 16/901; G06K 9/6289

(57) ABSTRACT

A method for operating a surroundings sensing device for a motor vehicle includes sensing the surroundings by at least one first surroundings sensor of the surroundings sensing device and by at least one second surroundings sensor of the surroundings sensing device; transmitting the surroundings sensed by the first surroundings sensor and the surroundings sensed by the second surroundings sensor to an electronic computing unit of the surroundings sensing device; performing grid-based evaluation of the surroundings for a first distance range of the surroundings by means of the electronic computing unit; performing fusion of the surroundings for a second distance range, which is different from the first distance range, by the electronic computing unit; and evaluating the surroundings depending on the grid-based evaluation and the fusion.

### BACKGROUND AND SUMMARY OF THE INVENTION

The invention relates to a method for operating a surroundings sensing device for a motor vehicle for sensing surroundings of the motor vehicle. Furthermore, the invention relates to a surroundings sensing device.

In the field of driver assistance and automated driving functions, static grids are already known for recognizing static obstacles, and a high-level object fusion is already known for recognizing and tracking dynamic objects, such as vehicles, trucks, pedestrians, or further things. A plurality of different surroundings sensors is typically installed in the vehicle. In high-level object fusion, object recognition and tracking of the object, which can also be referred to as tracking, are first carried out for the sensor data of each individual surroundings sensor and subsequently these tracked object lists are fused.

DE 10 2014 014 295 A1 discloses a method for monitoring a calibration of a plurality of sensor data from surroundings sensors, which record the surroundings of a motor vehicle and are installed at installation positions in the motor vehicle described by extrinsic calibration parameters, with respect to the extrinsic calibration parameters, wherein to ascertain a decalibration of at least one surroundings sensor, the same feature of the surroundings is evaluated in sensor data of different surroundings sensors describing the same properties by at least one decalibration criterion comparing the sensor data.

Furthermore, DE 10 2009 006 113 A1 relates to a device and a method for providing a surroundings representation of a vehicle having at least one first sensor unit, at least one second sensor unit, and an evaluation unit, wherein the sensor unit provides items of information about objects recognized in surroundings of the vehicle in the form of sensor objects, wherein a sensor object represents an object recognized by the respective sensor unit, and the sensor objects comprise as an attribute at least one existence probability of the represented object and the sensor objects recognized by the at least one first sensor unit and by the at least one second sensor unit are subjected to an object fusion, in which fusion objects are generated, to which at least one existence probability is assigned as an attribute, wherein the existence probabilities of the fusion objects are fused based on the existence probabilities of the sensor objects, wherein the fusion of the existence probability of one of the sensor objects takes place in each case in dependence on the respective sensor unit by which the corresponding sensor object is provided.

The object of the present invention is to provide a method and a surroundings sensing device by way of which the surroundings of the motor vehicle can be sensed in an improved manner.

This object is achieved by a method and a surroundings sensing device according to the claimed invention.

One aspect of the invention relates to a method for operating a surroundings sensing device for a motor vehicle for sensing surroundings of the motor vehicle. The surroundings are sensed using at least one first surroundings sensor of the surroundings sensing device and using at least one second surroundings sensor of the surroundings sensing device. The surroundings sensed by way of the first surroundings sensor and the surroundings sensed by way of the second surroundings sensor are transferred to an electronic computing unit of the surroundings sensing device. A grid-based evaluation of the transferred, sensed surroundings is carried out for a first distance range of the surroundings by way of the electronic computing unit. A fusion is carried out of the transferred, sensed surroundings for a second distance range different from the first distance range by way of the electronic computing unit. An evaluation of the surroundings is carried out as a function of the grid-based evaluation and the fusion by way of the electronic computing unit.

It is thus made possible that the surroundings can be sensed in an improved manner.

In particular, an embodiment of the invention thus solves the problem that the grid-based evaluation, which can also be referred to in particular as grid-based, is very robust, but also requires a higher computing effort. From a functional aspect, the highest possible range is desired with high accuracy, but this would also mean the greatest computing effort. It is thus provided according to an embodiment of the invention that the grid-based evaluation is combined with the fusion, which can also be referred to as high-level object fusion. In particular, a grid-based evaluation with high computing effort is thus carried out in the first distance range, while the high-level object fusion is carried out in the second distance range.

In other words, it is proposed in an embodiment of this invention, to manage the conflicting demands that corresponding object lists from the high-level object fusion be combined with the object lists from the dynamic grid including object tracking. The advantages of both sensing methods can thus be used.

In particular, it is possible using the surroundings sensing device to sense and track objects in the surroundings, in other words to track them. The objects can be both static objects and also dynamic objects.

In the surroundings sensors, it can be provided in particular that an ultrasonic sensor and/or a camera is used, for example, for the first distance range. For the second distance range, for example, a radar sensor and/or a lidar sensor can be used as surroundings sensors.

According to one advantageous embodiment, the first distance range is provided at a lesser distance to the motor vehicle than the second distance range. In other words, the grid-based evaluation takes place in particular in the close motor vehicle surroundings, while the fusion is carried out in the more remote motor vehicle surroundings. It is thus made possible that a high-resolution is provided for the first distance range, in other words for the close range, by which objects can be determined reliably and precisely. In the second distance range, in particular a long range can be achieved by way of the fusion, so that very remote objects can also be recognized and tracked.

It is furthermore advantageous if a dynamic grid is generated for the grid-based evaluation. The dynamic grid can also be referred to in particular as a dynamic occupancy grid. This dynamic grid can start from an expansion of a static grid. In particular, grid-based object tracking also takes place in the dynamic grid. In particular, it is thus made possible that objects in the surroundings can be tracked or sensed, which can be both static and also dynamic. In particular, this can advantageously be carried out by way of the dynamic grid in dense surroundings and in the case of atypical objects which have not yet previously been observed. In the grids, the surroundings are in particular divided into cells and a number of attributes is estimated per cell. These grids are very robust, but require a high computing effort. The required number of the corresponding cells of the grid is dependent in particular on two factors. In particular, a first factor is the range or the distance range and a second factor is the desired accuracy. It can be provided in particular here that the smaller a cell is, the more cells are required for the same distance range. In the dynamic grids, in contrast to the static grids, velocities and items of dynamic evidence per cell are also stored.

It is furthermore advantageous if the first distance range is evaluated decentered from the motor vehicle. For example, it can be provided that the first distance range is laid at least essentially in a circular or elliptical manner around the motor vehicle. However, in particular in certain situations, the sensing of a front region of the motor vehicle is more important than the sensing of a rear region of the motor vehicle. In particular, it can then be provided that this elliptical distance range is decentered, for example shifted farther in the direction of the front of the motor vehicle, so that the resolution in the decentered region is higher toward the front than in the rear region. The dynamic grid is typically formed to the front and to the side having a greater perspective and to the rear having a significantly lesser perspective. The resolution of the dynamic grid corresponds in particular to the desired accuracy of the static obstacles. Furthermore, the dynamic grid in particular covers the region in which a high resolution of dynamic objects is required.

In a further advantageous embodiment, at least the first distance range is decentered as a function of a determined position of the motor vehicle and/or as a function of a velocity of the motor vehicle. If, for example, the motor vehicle should be in urban surroundings, it may thus be provided that only the first distance range is shifted slightly forwards, so that the surroundings behind the motor vehicle and laterally to the motor vehicle can also be reliably sensed. If, for example, the motor vehicle should be underway on a freeway, in particular the front region in front of the motor vehicle is of greater importance, so that here in particular the first distance range is shifted forward. Furthermore, the shift of the dynamic grid can also be carried out depending on velocity. It is thus made possible that a corresponding shift of the grid can be carried out in dependence on the velocity and/or position.

In particular, the position of the motor vehicle in the grid can also change over time and thus the relationship between coverage to the front and to the rear. In urban surroundings, the motor vehicle will be centralized to have coverage at equal range in all directions, and the perspective forward can be greater on a freeway, for example.

Furthermore, it is advantageous if an object list having recognized objects is generated in each case upon the grid-based evaluation and upon the fusion, and these object lists are evaluated by way of the electronic computing unit. In particular, it is provided that an object list is created individually by each surroundings sensor, which are then fused together upon the fusion by the electronic computing unit. In particular, an object list is also generated on the basis of the dynamic grid. Tracking of the objects can thus be carried out in an improved manner in particular.

Furthermore, it has proven to be advantageous if an association between the object lists of the grid-based evaluation and the object lists of the fusion is carried out in a transition range between the first distance range and the second distance range. In particular, it is thus provided that the ranges outside the grid are covered by the fusion, in other words the high-level fusion. In the transition range between the dynamic grid and the high-level fusion, there is an association and a fusion or combination between the two object lists. It is thus made possible that both objects which move from close range into long range can be reliably transferred upon the evaluation and objects which move from long range into close range can also be reliably transferred. Improved operation of the surroundings sensing device is thus implemented.

It is also advantageous if a cell size is adapted in the grid-based evaluation as a function of a determined position of the motor vehicle and/or as a function of a velocity of the motor vehicle. In particular, it is proposed, for example, that in one time step, the resolution and the cell size of the grid remain the same. However, the cell size can change over time at equal resolution. For example, small cells can be implemented at shorter range in parking areas and larger cells at a longer range, for example, on a freeway. The surroundings can thus be detected in an improved manner.

Furthermore, it can be provided that a resolution is predefined to be constant in the grid-based evaluation. In other words, the resolution remains the same, but the cell size can change. Implementing improved object recognition in the surroundings of the motor vehicle is thus enabled in a simple manner.

A further aspect of the invention relates to a surroundings sensing device for a motor vehicle for sensing surroundings having at least two surroundings sensors and having at least one electronic computing unit, wherein the surroundings sensing device is designed to carry out a method according to the preceding aspect. In particular, the method is carried out by way of the surroundings sensing device.

Still a further aspect of the invention relates to a motor vehicle having a surroundings sensing device. The motor vehicle is designed in particular as a passenger vehicle.

Advantageous embodiments of the method are considered to be advantageous embodiments of the surroundings sensing device and the motor vehicle. The surroundings sensing device and the motor vehicle have features of the subject matter for this purpose, which enable the method and an advantageous embodiment thereof to be carried out.

Further features of the invention result from the claims, the figure, and the description of the figure. The features and combinations of features mentioned above in the description and the features and combinations of features mentioned hereinafter in the description of the figure and/or solely shown in the figure are usable not only in the respective specified combination but also in other combinations or alone.

The invention will now be explained in more detail on the basis of a preferred exemplary embodiment and with reference to the drawing.

### BRIEF DESCRIPTION OF THE DRAWING

FIG. 1 shows a schematic top view of a motor vehicle having an embodiment of a surroundings sensing device.

### DETAILED DESCRIPTION OF THE DRAWING

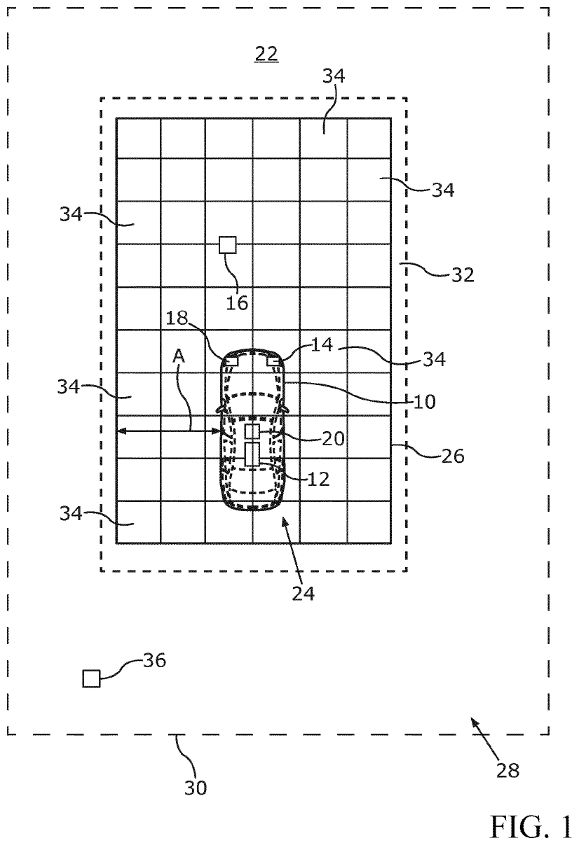

In FIG. 1, identical or functionally identical elements are provided with the same reference signs.

FIG. 1 shows a schematic top view of a motor vehicle 10 having an embodiment of a surroundings sensing device 12. The surroundings sensing device 12 has at least one first surroundings sensor 14 and a second surroundings sensor 18. Furthermore, the surroundings sensing device 12 has an electronic computing unit 20. The surroundings sensing device 12 is designed for the motor vehicle 10 to sense surroundings 22 of the motor vehicle 10.

In the method for operating the surroundings sensing device 12 for the motor vehicle 10 to sense the surroundings 22 of the motor vehicle 10, the surroundings 22 are sensed at least using the first surroundings sensor 14 and the second surroundings sensor 18. The surroundings 22 sensed by way of the first surroundings sensor 14 and the surroundings 22 sensed by way of the second surroundings sensor 18 are transferred to the electronic computing unit 20. A grid-based evaluation of the transferred, sensed surroundings 22 takes place for a first distance range 26 by way of the electronic computing unit 20, and a fusion 28 of the transferred detected surroundings 22 takes place for a second distance range 30, which is different from the first distance range 26, by way of the electronic computing unit 20. An evaluation of the surroundings 22 is carried out as a function of the grid-based evaluation 24 and the fusion 28 by way of the electronic computing unit 20.

In particular a first object 16 is located in the first distance range 26. In particular a second object 36 is located in the second distance range. In particular, the objects 16, 36 can be sensed by way of the surroundings sensing device 12.

In particular, it is provided that the first distance range 26 is provided at a lesser distance A to the motor vehicle 10 than the second distance range 30.

In particular, a dynamic grid is generated for the grid-based evaluation 24.

Furthermore, FIG. 1 shows that the first distance range 26 is evaluated decentered to the motor vehicle 10. In particular, at least the first distance range 26 can be decentered for this purpose as a function of a determined position of the motor vehicle 10 and/or as a function of a velocity of the motor vehicle 10.

Furthermore, it is provided in particular that an object list having recognized objects 16, 36 in the surroundings 22 is generated in each case in the grid-based evaluation 24 and in the fusion 28 and evaluation is carried out in these object lists by way of the electronic computing unit 20.

Furthermore, it can be provided in particular that an association between the object lists of the grid-based evaluation 24 and the object lists of the fusion 28 is carried out in a transition range 32 between the first distance range 26 and the second distance range 30.

In particular, it can be provided that a cell size 34 is adapted in the grid-based evaluation 24 as a function of a determined position of the motor vehicle 10 and/or as a function of a velocity of the motor vehicle 10. In particular, it is also provided that the resolution is predefined to be constant in the grid-based evaluation 24.

In particular, the embodiment of the invention shown in FIG. 1 thus solves the problem that the grid-based evaluation 24 is very computing intensive. In particular, however, the grid-based evaluation 24 has a high resolution. To save computing capacity, the grid-based evaluation 24 is carried out in the first distance range 26 and the fusion 28 is carried out in the second distance range 30. The fusion 28 is in particular a high-level object fusion.

In particular, it is thus provided that objects 16, 36 can be sensed by way of the surroundings sensing device 12. The objects 16, 36 can be both static and also dynamic.

In other words, to manage the conflicting requirements, it is proposed that the object lists of the high-level object fusion be combined with the object lists from the dynamic grid, including grid-based object tracking function. The dynamic grid is at least as large with respect to size, accuracy in the first distance range 26 as the range in which relevant static obstacles, in other words static objects 16, 36, are. This is typically the case with greater perspective to the front and to the side and with significantly lesser distance A to the rear. The resolution corresponds to the desired accuracy of the static objects 16, 36. In addition, the size of the dynamic grid covers the range in which a high resolution of dynamic objects 16, 36 is required. The ranges outside the grid are covered by the high-level fusion, in other words the fusion 28. In the transition range 32 between dynamic grid and the high-level fusion, there is an association of the fusion 28 and a combination of the two object lists. Although the dynamic grid having fixed resolution and cell size 34 in one time step is proposed, the cell size 34 can certainly change over time at equal resolution. For example, small cells at shorter range can be implemented in parking areas and larger cells can be specified at a high range on freeways. Furthermore, it can be provided that the position of the motor vehicle 10 in relation to the grid also changes over time and thus the relationship between coverage to the front and to the rear also changes. In urban surroundings 22, the motor vehicle 10 can be centered in order to have a coverage to equal distances in all directions, while the perspective to the front is greater on a freeway, for example, and thus decentering takes place.

Overall, an embodiment of the invention discloses a method for recognizing objects 16, 36 and obstacles for long ranges and high accuracies.

### LIST OF REFERENCE SIGNS

10 motor vehicle
12 surroundings sensing device
14 first surroundings sensor
16 first object
18 second surroundings sensor
20 electronic computing unit
22 surroundings
24 grid-based evaluation
26 first distance range
28 fusion
30 second distance range
32 transition range
34 cell size
36 object
A distance

1.-10. (canceled)

11. A method for operating a surroundings sensing device for a motor vehicle for sensing surroundings of the motor vehicle, the method comprising:
sensing the surroundings using at least one first surroundings sensor of the surroundings sensing device and using at least one second surroundings sensor of the surroundings sensing device;
transferring the surroundings sensed by the first surroundings sensor and the surroundings sensed by the second surroundings sensor to an electronic computing unit of the surroundings sensing device;
performing grid-based evaluation of the surroundings for a first distance range of the surroundings by the electronic computing unit;
performing fusion of the surroundings for a second distance range different from the first distance range by the electronic computing unit; and
evaluating the surroundings as a function of the grid-based evaluation and the fusion by the electronic computing unit.

12. The method according to claim 11, wherein:
the first distance range is provided at a lesser distance to the motor vehicle than the second distance range.

13. The method according to claim 11, wherein:
a dynamic grid is generated for the grid-based evaluation.

14. The method according to claim 11, wherein:
the first distance range is evaluated decentered in relation to the motor vehicle.

15. The method according to claim 14, wherein:
at least the first distance range is decentered as a function of at least one of a determined position of the motor vehicle or a velocity of the motor vehicle.

16. The method according to claim 11, wherein:
an object list having recognized objects in the surroundings is generated in each of the grid-based evaluation and in the fusion, and the object lists are evaluated by the electronic computing unit.

17. The method according to claim 16, wherein:
an association between the object lists of the grid-based evaluation and the object lists of the fusion is carried out in a transition range between the first distance range and the second distance range.

18. The method according to claim 11, wherein:
a cell size is adapted in the grid-based evaluation as a function of at least one of a determined position of the motor vehicle or a velocity of the motor vehicle.

19. The method according to claim 11, wherein:
a resolution is specified to be constant in the grid-based evaluation.

20. A surroundings sensing device for a motor vehicle for sensing surroundings, the surrounding sensing device comprising:
at least two surroundings sensors;
at least one electronic computing unit; and
a processor configured to carry out a method comprising:
sensing the surroundings using at least one first surroundings sensor of the surroundings sensing device and using at least one second surroundings sensor of the surroundings sensing device;
transferring the surroundings sensed by the first surroundings sensor and the surroundings sensed by the second surroundings sensor to an electronic computing unit of the surroundings sensing device;
performing grid-based evaluation of the surroundings for a first distance range of the surroundings by the electronic computing unit;
performing fusion of the surroundings for a second distance range different from the first distance range by the electronic computing unit; and
evaluating the surroundings as a function of the grid-based evaluation and the fusion by the electronic computing unit.
